(19) United States
(12) Patent Application Publication
(10) Pub. No.: US 2004/0268379 A1
(43) Pub. Date: Dec. 30, 2004

(54) Storage media volumetric factor

(75) Inventor: William R. Qualls, River Falls, WI (US)

Correspondence Address: Attention: Eric D. Levinson, Imation Corp., Legal Affairs, P.O. Box 64898, St. Paul, MN, 55164-0898, US

(73) Assignee: Imation Corp., St. Paul, MN

(21) Appl. No.: 10/609,765

(22) Filed: Jun. 30, 2003

(51) Int. Cl. G11B 23/02; G11B 3/70; G11B 5/84; G11B 7/26

(52) U.S. Cl. 720/718; 360/132

(57) ABSTRACT

A data storage product includes a recordable layer having a recordable area and a characteristic width, and a product container having a container volume containing the recordable layer. The data storage product has a storage media volumetric factor defined as the characteristic width of the recordable layer multiplied by the recordable area of the recordable layer divided by the container volume of the product container, wherein the storage media volumetric factor of the data storage product is greater than approximately 450.

### THE FIELD OF THE INVENTION

The present invention relates generally to data storage products, and, more particularly, to a storage media volumetric factor for a data storage product.

### BACKGROUND OF THE INVENTION

Data storage products are commonly used for storage and distribution of information for subsequent retrieval and use. Data storage products include, for example, magnetic data storage products such as data storage tape cartridges, and optical data storage products such as optical data storage disks.

Data storage tape cartridges generally include a housing, a tape reel rotatably disposed within the housing, and a length of magnetic storage tape wound around the tape reel. As such, data may be read from or written to the magnetic storage tape by a magnetic read/write head of a tape drive system. Data storage tape cartridges may include a dual tape reel configuration where interaction between the magnetic storage tape and the read/write head takes place within or very near the housing, or a single tape reel configuration where interaction between the magnetic storage tape and the read/write head takes place away from the housing.

Optical data storage disks include a layer which may be read or written on by a laser of an optical drive system. Formats of optical data storage disks include, for example, compact disk (CD) media, CD-recordable (CD-R) media, CD-read only memory (CD-ROM) media, CD-rewritable (CD-RW) media, digital versatile disk or digital video disk (DVD) media, DVD-random access memory (DVD-RAM) media, and other types of rewritable optical media, such as magneto-optical (MO) disks and phase-change optical disks.

Data storage products are often marketed by storage capacity (e.g., megabytes (MB) or gigabytes (GB)). In an ongoing effort to increase the storage capacity of data storage products, efforts have typically focused on three primary variables including bit density, track density, and encoding. While each of these variables influences overall storage capacity, they are often difficult to change and implement. For example, each major change can adversely affect backward compatibility, thus limiting the lifespan of a particular drive system or platform. Furthermore, storage capacity may not necessarily reflect the overall value of a given data storage product as perceived by the customer.

Accordingly, it is desirable to define a storage media volumetric factor for a data storage product representing a total recordable capacity of the data storage product per unit size of the data storage product.

### SUMMARY OF THE INVENTION

One aspect of the present invention relates to a data storage product. The data storage product includes a recordable layer having a recordable area and a characteristic width, and a product container having a container volume containing the recordable layer. The data storage product has a storage media volumetric factor defined as the characteristic width of the recordable layer multiplied by the recordable area of the recordable layer divided by the container volume of the product container, wherein the storage media volumetric factor of the data storage product is greater than approximately 450.

Another aspect of the present invention relates to a method of forming a data storage product. The method includes providing a recordable layer, including defining a recordable area and a characteristic width of the recordable layer, containing the recordable layer in a product container, including defining a container volume of the product container, and defining a storage media volumetric factor for the data storage product, including multiplying the characteristic width of the recordable layer by a result of the recordable area of the recordable layer divided by the container volume of the product container, wherein the storage media volumetric factor of the data storage product is greater than approximately 450.

Another aspect of the present invention relates to a product for storing data. The product includes means for storing the data having a recordable area and a characteristic width, and means for containing the stored data having a container volume. The product has a storage media volumetric factor defined as the characteristic width multiplied by the recordable area divided by the container volume, wherein the storage media volumetric factor of the product is greater than approximately 450.

Another aspect of the present invention relates to a method of storing data. The method includes recording the data on a layer having an area and a width, and containing the layer in a container having a volume, wherein the width of the layer multiplied by the area of the layer divided by the volume of the container is greater than approximately 450.

### BRIEF DESCRIPTION OF THE DRAWINGS

FIG. 1 is a perspective view of one embodiment of a data storage tape cartridge constituting one embodiment of a data storage product according to the present invention.

FIG. 2 is a perspective view of one embodiment of a data storage tape cartridge with a portion of the housing removed.

FIG. 3 is an exploded perspective view of another embodiment of a data storage tape cartridge.

FIG. 4 is a simplified cross-sectional view of one embodiment of magnetic storage tape of a data storage tape cartridge.

FIG. 5 is a perspective view of one embodiment of an optical data storage disk constituting another embodiment of a data storage product according to the present invention.

FIG. 6 is a simplified cross-sectional view of one embodiment of an optical data storage disk.

FIGS. 7 and 8 include tables defining a storage media volumetric factor according to the present invention for a plurality of data storage products.

FIG. 9 is a chart illustrating a storage media volumetric factor according to the present invention compared with storage capacity for a plurality of data storage products.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

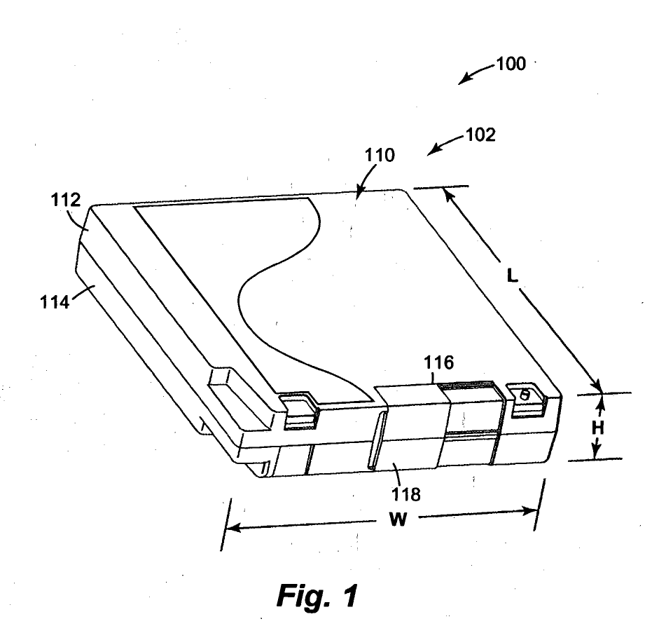

FIGS. 1-3 illustrate one! embodiment of a data storage product. Data storage product 100 includes a data storage tape cartridge 102. Data storage tape cartridge 102 includes a housing 110, one or more tape reels 120, and a length of magnetic storage tape 130. Tape reel 120 is rotatably disposed within housing 110 and magnetic storage tape 130 is wound around a portion of tape reel 120.

In one embodiment, housing 110 is formed by housing sections 112 and 114 each configured to be reciprocally mated to one another to form an enclosure or container for magnetic storage tape 130. As such, housing sections 112 and 114 combine to form a window 116 through which magnetic storage tape 130 can be accessed. In one embodiment, data storage tape cartridge 102 includes a door 118 slidably secured to housing 110 such that door 118 can be selectively moved to provide access to window 116.

Preferably, housing 110 is sized to be received by a standard tape drive (not shown). Housing 110 may be sized, for example, for use with a 5.25 inch (130 mm) form factor drive, a 3.5 inch (90 mm) form factor drive, or other size tape drive. In one embodiment, as illustrated in FIG. 1, data storage tape cartridge 102 has a length (L), a width (W), and a height (H). The length, width, and height of data storage tape cartridge 102 are used to define a storage media volumetric factor for data storage tape cartridge 102, as described below.

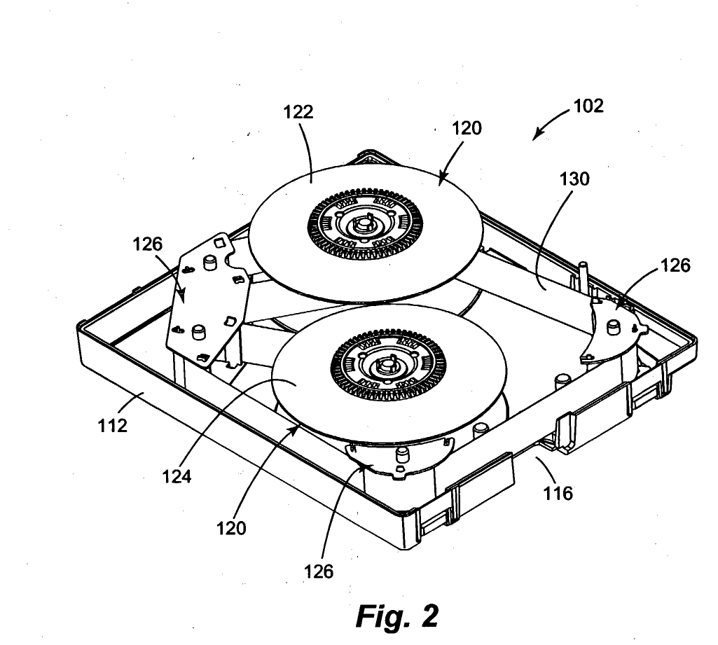

In one embodiment, as illustrated in FIG. 2, data storage tape cartridge 102 includes a first tape reel 122, a second tape reel 124, and a plurality of guides 126. As such, tape reels 122 and 124, and guides 126 cooperate to define a tape path for magnetic storage tape 130 within housing 110. Magnetic storage tape 130 is fed, for example, from tape reel 122 and guided through housing 110 by guides 126 to tape reel 124. While magnetic storage tape 130 is guided through housing 110, magnetic storage tape 130 is guided along window 116 to permit interaction with magnetic storage tape 130 by a read/write head (not shown). It will be recognized by one of skill in the art that the illustrated tape path is but one of many available configurations. By incorporating different guides at various locations, the resulting tape path may be substantially different from that shown in FIG. 2.

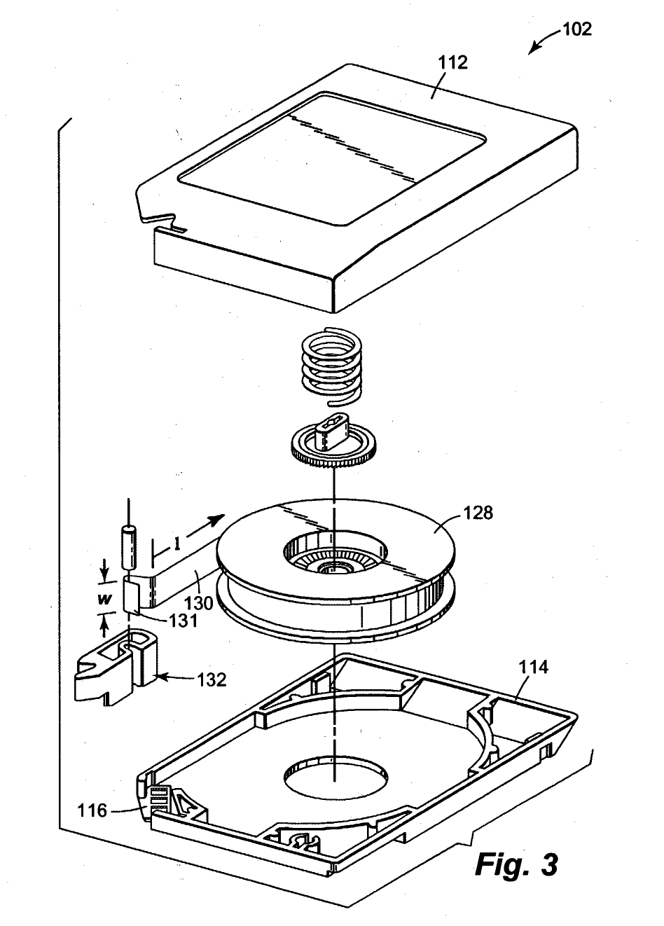

In another embodiment, as illustrated in FIG. 3, data storage tape cartridge 102 includes a single tape reel 128. In addition, data storage tape cartridge 102 includes a leader block 132 to which a free end 131 of magnetic storage tape 130 is attached. As such, leader block 132 is engaged by a tape drive mechanism (not shown) such that magnetic storage tape 130 is fed from tape reel 128 through window 116 and directed along a tape path within the tape drive mechanism. Thus, the tape drive mechanism directs magnetic storage tape 130 into engagement with a read/write head (not shown).

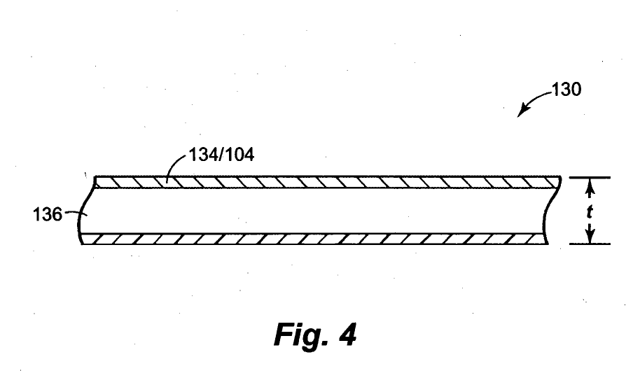

FIG. 4 is a cross-sectional view illustrating one embodiment of magnetic storage tape 130. Magnetic storage tape 130 includes a magnetic layer 134 coated onto at least one side of a non-magnetic substrate 136 (e.g., a film for magnetic recording tape applications). As such, magnetic layer 134 constitutes a recordable layer 104 for data storage tape cartridge 102.

It is understood that FIG. 4 is a simplified schematic illustration of one embodiment of magnetic storage tape 130, and that additional layers or coatings may be formed on and/or applied to one or more sides of magnetic layer 134 and/or substrate 136. In addition, in one embodiment, magnetic storage tape 130 facilitates one-sided recording. Thus, magnetic storage tape 130 includes one magnetic layer 134. In another embodiment, however, magnetic storage tape 130 facilitates two-sided recording. Thus, magnetic storage tape 130 includes two magnetic layers 134.

In one embodiment, as illustrated in FIGS. 3 and 4, magnetic storage tape 130 has a length (l), a width (w), and a thickness (t). The thickness of magnetic storage tape 130 affects the length of magnetic storage tape 130 that can be housed within data storage tape cartridge 102. The length and width of magnetic storage tape 130 are used to define a storage media volumetric factor for data storage tape cartridge 102, as described below.

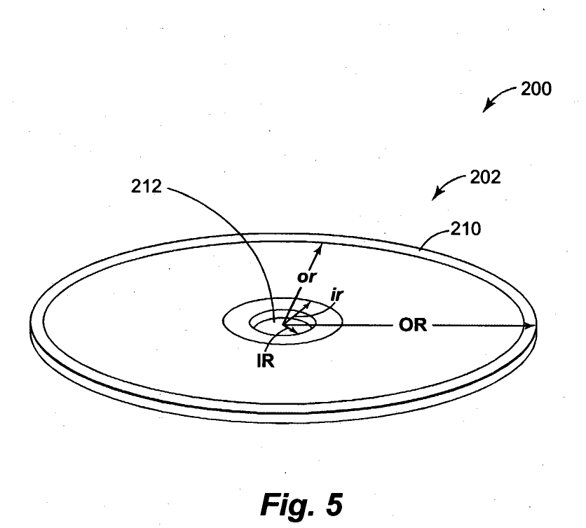

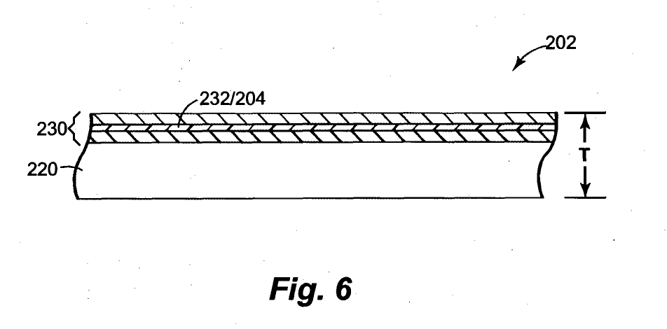

FIGS. 5 and 6 illustrate another embodiment of a data storage product. Data storage product 200 includes an optical data storage disk 202. Optical data storage disk 202 includes a circular member 210 having a central bore or opening 212 formed therein. In one embodiment, a central hub forms opening 212. Preferably, opening 212 is sized to accommodate a drive pin or other engagement feature of an optical disk drive (not shown).

FIG. 6 is a cross-sectional view illustrating one embodiment of optical data storage disk 202. Optical data storage disk 202 includes a substrate 220 and one or more layers 230 formed on substrate 220. Preferably, at least one layer 232 constitutes a recordable layer 204 for optical data storage disk 202. As such, optical data storage disk 202 constitutes a container for recordable layer 204.

It is understood that FIG. 6 is a simplified schematic illustration of one embodiment of optical data storage disk 202, and that additional or fewer layers than that illustrated may be formed on one or more sides of substrate 220. Additional layers 230 of optical data storage disk 202 may include, for example, protective, reflective, and/or dielectric layers. In one embodiment, optical data storage disk 202 includes multiple recordable layers 204 each facilitating one-sided and/or two-sided recording.

In one embodiment, as illustrated in FIGS. 5 and 6, optical data storage disk 202 has an inner radius (IR), an outer radius (OR), and a thickness (T). In addition, recordable layer 204 of optical data storage disk 202 has an inner radius (ir) and an outer radius (or). The inner radius, outer radius, and thickness of optical data storage disk 202, and the inner radius and outer radius of recordable layer 204 are used to define a storage media volumetric factor for optical storage disk 202, as described below.

As described above, data storage tape cartridge 102 and optical data storage disk 202 each constitute one embodiment of a data storage product. More specifically, data storage tape cartridge 102 represents an example of a magnetic storage medium and optical data storage disk 202 represents an example of an optical storage medium. As such, data storage tape cartridge 102 and optical data storage disk 202 each include a data storage medium for recording and storing information for subsequent retrieval and use. For example, recordable layer 104 constitutes a data storage medium of data storage tape cartridge 102, and recordable layer 204 constitutes a data storage medium of optical data storage disk 202.

In one embodiment, a storage media volumetric factor (SMVF) is defined for each data storage product. In one embodiment, the storage media volumetric factor for a data storage product is expressed as:

(A_{REC}/V_{CONT})*W_{CHAR}

where A_{REC} is a recordable area of the data storage medium of the data storage product; V_{CONT} is a volume of a structure or container wherein or whereon the data storage medium of the data storage product is contained; and W_{CHAR} is a characteristic width of the data storage medium of the data storage product.

In one embodiment, when defining a storage media volumetric factor for data storage tape cartridge 102, the recordable area (A_{REC}) of data storage tape cartridge 102 is expressed as:

A_{REC}=l *W*n

and the characteristic width (W_{CHAR}) of data storage tape cartridge 102 is expressed as:

W_{CHAR}=W

where l is the length of magnetic storage tape 130, w is the width of magnetic storage tape 130, and n is the number of recordable areas (e.g., recordable sides) of magnetic storage tape 130. In one embodiment, wherein magnetic storage tape 130 facilitates one-sided recording, n is one. In another embodiment, wherein magnetic storage tape 130 facilitates two-sided recording, n is two.

In addition, when defining the storage media volumetric factor for data storage tape cartridge 102, the container volume (V_{CONT}) of data storage tape cartridge 102 is defined as a volume of housing 110 and is expressed as:

V_{CONT}=L*W*H

where L is the length of housing 110, W is the width of housing 110, and H is the height of housing 110.

In one embodiment, when defining a storage media volumetric factor for optical data storage disk 202, the recordable area (A_{REC}) of optical data storage disk 202 is expressed as:

A_{REC}=pi*(orΔ2−irΔ2)*n

and the characteristic width (W_{CHAR}) of optical data storage disk 202 is expressed as:

W_{CHAR}=or−ir

where or is the outer radius of recordable layer 204, ir is the inner radius of recordable layer 204, and n is the number of recordable areas (e.g., recordable layers and/or sides) of optical data storage disk 202.

In addition, when defining the storage media volumetric factor for optical data storage disk 202, the container volume (V_{CONT}) of optical data storage disk 202 is defined as a volume of optical data storage disk 202 and is expressed as:

V_{CONT}=pi*(ORΔ2−IRΔ2)*T

where OR is the outer radius of optical data storage disk 202, IR is the inner radius of optical data storage disk 202, and T is the thickness of optical data storage disk 202.

Calculating storage media volumetric factor (SMVF) for optical data storage disk 202, including calculating recordable, area (A_{REC}), characteristic width (W_{CHAR}), and/or container volume (V_{CONT}) as described above, is one example of calculating a storage media volumetric factor for a circular data storage product. Accordingly, it is understood that similar calculations can be performed for any other circular data storage product.

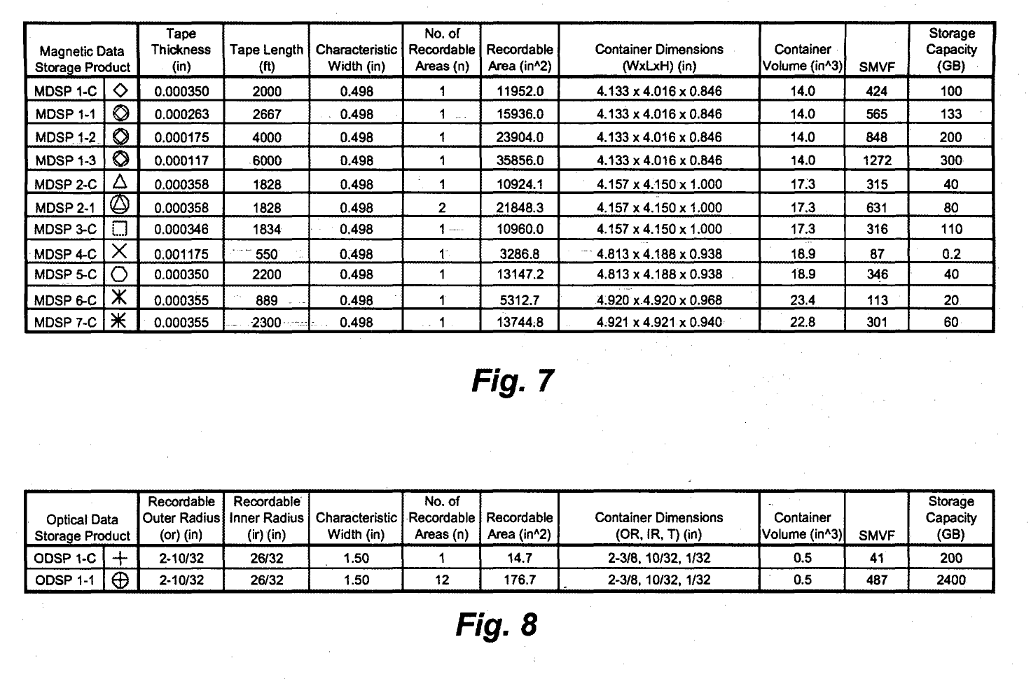

FIGS. 7 and 8 include tables defining storage media volumetric factors for a plurality of magnetic data storage products (MDSP) and optical data storage products (ODSP), respectively. As such, each of the tables include a characteristic width, a number of recordable areas, a recordable area, container dimensions, and a container volume for each of the data storage products. In addition, a storage capacity of each of the data storage products is provided.

In the table of FIG. 7, magnetic data storage products MDSP 1-C, MDSP 2-C, MDSP 3-C, MDSP 4-C, MDSP 5-C, MDSP 6-C, and MDSP 7-C include comparative examples of storage media volumetric factors for various data storage tape cartridges. In one exemplary embodiment, MDSP 1-C includes an Ultrium 1 single reel tape cartridge, MDSP 2-C includes a DLT single reel tape cartridge, MDSP 3-C includes a Super DLT (SDLT) single reel tape cartridge, MDSP 4-C includes a 3480 single reel tape cartridge, MDSP 5-C includes a 3590E single reel tape cartridge, MDSP 6-C includes a 9840 dual reel tape cartridge, and MDSP 7-C includes a 9940 dual reel tape cartridge, each of which are available from Imation Corp. of Oakdale, Minn. As outlined in the table of FIG. 7, the SMVF for MDSP 1-C is 424, the SMVF for MDSP 2-C is 315, the SMVF for MDSP 3-C is 316, the SMVF for MDSP 4-C is 87, the SMVF for MDSP 5-C is 346, the SMVF for MDSP 6-C is 113, and the SMVF for MDSP 7-C is 301.

In the table of FIG. 7, magnetic data storage products MDSP 1-1, MDSP 1-2, MDSP 1-3, and MDSP 2-1 include examples of data storage tape cartridges with storage media volumetric factors according to the present invention. More specifically, magnetic data storage products MDSP 1-1, MDSP 1-2, MDSP 1-3, and MDSP 2-1 each have an SMVF greater than approximately 450. In one exemplary embodiment, magnetic data storage products MDSP 1-1, MDSP 1-2, MDSP 1-3, and MDSP 2-1 each have an SMVF within a range of about 450 to about 1500.

In one exemplary embodiment, magnetic data storage products MDSP 1-1, MDSP 1-2, and MDSP 1-3 include Ultrium 1 single reel tape cartridges with decreasing tape thickness (t) of magnetic storage tape 130. By decreasing tape thickness (t) of magnetic storage tape 130, data storage tape cartridge 102 can accommodate more magnetic storage tape 130. More specifically, a length (1) of magnetic storage tape 130 within data storage tape cartridge 102 can be increased.

In one embodiment, tape thickness (t) of magnetic storage tape 130 is decreased by decreasing a thickness of substrate 136 of magnetic storage tape 130. For example, substrate 136 of magnetic storage tape 130 of comparative magnetic data storage product MDSP 1-C has a thickness of 24 gauge. In one exemplary embodiment, substrate 136 of magnetic storage tape 130 of magnetic data storage product MDSP 1-1 has a thickness of 18 gauge. As such, tape thickness (t) of magnetic storage tape 130 is decreased. Thus, tape length (l) of magnetic storage tape 130 can be increased. Accordingly, SMVF for magnetic data storage product MDSP 1-1 is increased from that of magnetic data storage product MDSP 1-C. In one exemplary embodiment, substrate 136 of magnetic storage tape 130 of magnetic data storage products MDSP 1-2 and MDSP 1-3 have a thickness of 12 gauge and 8 gauge, respectively. As such, tape thickness (t) of magnetic storage tape 130 is decreased and tape length (l) of magnetic storage tape 130 can be increased. Accordingly, SMVF for magnetic data storage products MDSP 1-2 and MDSP 1-3 are increased.

In one exemplary embodiment, magnetic data storage product MDSP 2-1 includes a DLT single reel tape cartridge with magnetic storage tape 130 facilitating two-sided recording. With two-sided recording, the number of recordable areas (n) of magnetic storage tape 130 is doubled. Accordingly, SMVF for magnetic data storage product MDSP 2-1 is increased from that of comparative magnetic data storage product MDSP 1-C.

In the table of FIG. 8, optical data storage product ODSP 1-C includes a comparative example of a storage media volumetric factor for an optical data storage disk. In one embodiment, optical data storage product ODSP 1-C includes a compact disk recordable (CD-R) media available from Imation Corp. of Oakdale, Minn. As outlined in the table of FIG. 8, the SMVF for ODSP 1-C is 41.

In the table of FIG. 8, optical data storage product ODSP 1-1 includes an example of an optical data storage disk with a storage media volumetric factor according to the present invention. More specifically, optical data storage product ODSP 1-1 has an SMVF greater than approximately 450. In one exemplary embodiment, optical data storage product ODSP 1-1 has an SMVF within a range of about 450 to about 1500.

In one exemplary embodiment, optical data storage product ODSP 1-1 includes a compact disk recordable (CD-R) media facilitating multi-layer and/or multi-side recording. With multi-layer and/or multi-side recording, the number of recordable areas (n) of optical data storage disk 202 is increased. Accordingly, SMVF for optical data storage product ODSP 1-1 is increased from that of comparative optical data storage product ODSP 1-C.

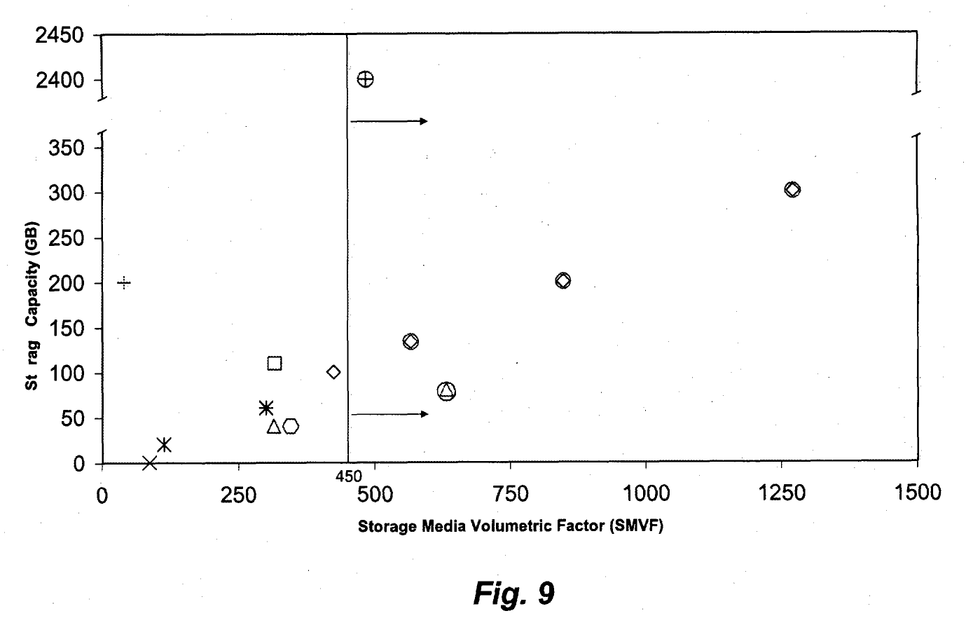

In the chart of FIG. 9, storage media volumetric factor (SMVF) is compared with storage capacity for the magnetic data storage products (MDSP) and optical data storage products (ODSP) of the tables of FIGS. 7 and 8. As illustrated in the chart of FIG. 9, magnetic data storage products MDSP 1-1, MDSP 1-2, MDSP 1-3, and MDSP 2-1, and optical data storage product ODSP 1-1 each have an SMVF greater than approximately 450.

By defining a storage media volumetric factor for a data storage product, a recordable capacity of a data storage product per unit size of the data storage product can be identified. Decreasing tape thickness of magnetic storage tape 130 so as to enable an increase in tape length within housing 110 of data storage tape cartridge 102 and/or recording on both sides of magnetic storage tape 130 are examples of increasing a recordable area of data storage tape cartridge 102 for a given volume of housing 110 of data storage tape cartridge 102. In addition, recording on multiple layers and/or sides is an example of increasing a recordable area of optical data storage disk 202 for a given volume of optical data storage disk 202. Accordingly, an increase, in the recordable area of a data storage product for a given container volume of the data storage product, for example, results in an increase in a: storage media volumetric factor for the data storage product.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A data storage product, comprising:
a recordable layer having a recordable area and a characteristic width; and
a product container having a container volume containing the recordable layer,
wherein the data storage product has a storage media volumetric factor defined as the characteristic width of the recordable layer multiplied by the recordable area of the recordable layer divided by the container volume of the product container, and
wherein the storage media volumetric factor of the data storage product is greater than approximately 450.

2. The data storage product of claim 1, wherein the data storage product includes a magnetic storage medium.

3. The data storage product of claim 1, wherein the data storage product includes an optical storage medium.

4. The data storage product of claim 1, wherein the data storage product includes a data storage tape cartridge including magnetic storage tape and a housing maintaining the magnetic storage tape, wherein the magnetic storage tape includes the recordable layer and the housing constitutes the product container.

5. The data storage product of claim 4, wherein the data storage tape cartridge includes at least one tape reel, and wherein the magnetic storage tape is wound around the at least one tape reel.

6. The data storage product of claim 4, wherein the magnetic storage tape of the data storage tape cartridge has a length and a width, and wherein the recordable area is defined as a number of recordable areas of the data storage tape cartridge multiplied by the length of the magnetic storage tape multiplied by the width of the magnetic storage tape, and the characteristic width is defined as the width of the magnetic storage tape.

7. The data storage product of claim 4, wherein the housing of the data storage tape cartridge has a length, a width, and a height, and wherein the container volume is defined as the length of the housing multiplied by the width of the housing multiplied by the height of the housing.

8. The data storage product of claim 1, wherein the data storage product includes an optical data storage disk, and wherein the recordable layer includes at least one layer of the optical data storage disk and the optical data storage disk constitutes the product container.

9. The data storage product of claim 8, wherein the at least one layer of the optical data storage disk has an inner radius and an outer radius, and wherein the recordable area is defined as a number of recordable areas of the at least one layer multiplied by pi multiplied by a result of the inner radius of the at least one layer squared subtracted from the outer radius of the at least one layer squared, and the characteristic width is defined as the inner radius of the at least one layer subtracted from the outer radius of the at least one layer.

10. The data storage product of claim 8, wherein the optical data storage disk has an inner radius, an outer radius, and a thickness, and wherein the container volume is defined as the thickness of the optical data storage disk multiplied by pi multiplied by a result of the inner radius of the optical data storage disk squared subtracted from the outer radius of the optical data storage disk squared.

11. The data storage product of claim 1, wherein the storage media volumetric factor of the data storage product is in a range of approximately 450 to approximately 1500.

12. A method of forming a data storage product, the method comprising:
providing a recordable layer, including defining a recordable area and a characteristic width of the recordable layer;
containing the recordable layer in a product container, including defining a container volume of the product container; and
defining a storage media volumetric factor for the data storage product, including multiplying the characteristic width of the recordable layer by a result of the recordable area of the recordable layer divided by the container volume of the product container,
wherein the storage media volumetric factor of the data storage product is greater than approximately 450.

13. The method of claim 12, wherein the data storage product includes a magnetic storage medium.

14. The method of claim 12, wherein the data storage product includes an optical storage medium.

15. The method of claim 12, wherein containing the recordable layer includes winding the recordable layer within the product container.

16. The method of claim 12, wherein containing the recordable layer includes embedding the recordable layer in the product container.

17. The method of claim 12, wherein the data storage product includes a data storage tape cartridge, wherein providing the recordable layer includes providing magnetic storage tape having the recordable layer, and wherein containing the recordable layer includes maintaining the magnetic storage tape within a housing constituting the product container.

18. The method of claim 17, wherein maintaining the magnetic storage tape includes winding the magnetic storage tape around at least one tape reel of the data storage tape cartridge.

19. The method of claim 17, wherein the magnetic storage tape of the data storage tape cartridge has a length and a width, and wherein defining the recordable area includes multiplying a number of recordable areas of the data storage tape cartridge by the length of the magnetic storage tape and the width of the magnetic storage tape, and defining the characteristic width includes defining the characteristic width as the width of the magnetic storage tape.

20. The method of claim 17, wherein the housing of the data storage tape cartridge has a length, a width, and a height, and wherein defining the container volume includes multiplying the length of the housing by the width of the housing and the height of the housing.

21. The method of claim 12, wherein the data storage product includes an optical data storage disk including at least one layer constituting the recordable layer.

22. The method of claim 21, wherein the at least one layer of the optical data storage disk has an inner radius and an outer radius, and wherein defining the recordable area includes multiplying a number of recordable areas of the optical data storage disk by pi and a result of the inner radius of the at least one layer squared subtracted from the outer radius of the at least one layer squared, and defining the characteristic width includes subtracting the inner radius of the at least one layer from the outer radius of the at least one layer.

23. The method of claim 21, wherein the optical data storage disk has an inner radius, an outer radius, and a thickness, and wherein defining the container volume includes multiplying the thickness of the optical data storage disk by pi and a result of the inner radius of the optical data storage disk squared subtracted from the outer radius of the optical data storage disk squared.

24. The method of claim 12, wherein the storage media volumetric factor of the data storage product is in a range of approximately 450 to approximately 1500.

25. A product for storing data, the product comprising:
means for storing the data having a recordable area and a characteristic width; and
means for containing the stored data having a container volume,
wherein the product has a storage media volumetric factor defined as the characteristic width multiplied by the recordable area divided by the container volume, and
wherein the storage media volumetric factor of the product is greater than approximately 450.

26. The product of claim 25, wherein means for storing the data includes means for magnetically storing the data.

27. The product of claim 25, wherein means for storing the data includes means for optically storing the data.

28. The product of claim 25, further comprising:
means for increasing the storage media volumetric factor of the product.

29. The product of claim 28, wherein means for increasing the storage media volumetric factor includes means for increasing the recordable area for a given container volume.

30. The product of claim 29, wherein means for increasing the recordable area includes means for increasing a length of the recordable area for the given container volume.

31. The product of claim 29, wherein means for increasing the recordable area includes means for increasing a number of recordable areas for the given container volume.

32. The product of claim 25, wherein the storage media volumetric factor of the product is in a range of approximately 450 to approximately 1500.

33. A method of storing data, the method comprising:
recording the data on a layer having an area and a width; and
containing the layer in a container having a volume,
wherein the width of the layer multiplied by the area of the layer divided by the volume of the container is greater than approximately 450.

34. The method of claim 33, wherein recording the data includes magnetically recording the data on the layer.

35. The method of claim 33, wherein recording the data includes optically recording the data on the layer.

36. The method of claim 33, wherein the width of the layer multiplied by the area of the layer divided by the volume of the container is in a range of approximately 450 to approximately 1500.
